(19) United States
(12) Patent Application Publication
(10) Pub. No.: US 2006/0290993 A1
(43) Pub. Date: Dec. 28, 2006

(54) Image reading apparatus and image processing method therefor, image formation apparatus, image processing system and image processing method therefor

(75) Inventors: Tadaomi Suzuki, Kanagawa (JP); Takashi Kurihara, Saitama (JP); Kazuhiko Minowa, Saitama (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/247,226

(22) Filed: Oct. 12, 2005

(30) Foreign Application Priority Data
Jun. 23, 2005 (JP) 2005-183641

(51) Int. Cl. H04N 1/40

(52) U.S. Cl. 358/3.28; 358/1.15; 358/474

(57) ABSTRACT

An image reading apparatus connected to an image formation apparatus generates an image data for each page of an original document and instructs to add an additional object to the image data. When the addition of the additional object is instructed, an additional object image is generated according to the instruction, and the generated additional object image is incorporated to the image data. A file of a predetermined format is generated according to the image data to which the additional object is incorporated, and is output to the image formation apparatus.

### BACKGROUND OF THE INVENTION

1. Field of the Invention

The present invention relates to an image reading apparatus and an image processing method therefor, an image formation apparatus, an image processing system and an image processing method therefor. In particular, the present invention relates to an image reading apparatus and an image processing method therefor, an image formation apparatus, an image processing system and an image processing method therefor, which improve the first copy output time (FCOT) of direct print in a peer-to-peer (P2P)—connected scanner/printer system.

2. Description of the Related Art

In recent years, various systems to connect a plurality of image processing apparatuses such as scanners and printers have been proposed. Most of such systems employ a local area network (LAN) as an interface to connect the image processing apparatuses. This is because the use of the LAN interface enables the use of universal technologies both physically and logically, and also allows the individual image processing apparatuses to be coupled loosely, which increases the independence of each of the image processing apparatuses.

For example, if two or more images are to be synthesized by a personal computer (PC) connected via a network, the PC must have vast resources (e.g., CPU power and memory). Therefore, a printer control method and apparatus has been proposed to cause a printer to perform the synthesis of the images (see, for example, Japanese Patent Application Publication 06-340127).

However, such systems have a problem that the size of the systems as a whole becomes large, which in turn increases the introduction cost and maintenance cost of the systems.

To solve this problem, there has recently been proposed a scanner/printer system in which a scanner and a printer are connected in peer-to-peer (P2P) connection using an interface that is loosely coupled both in terms of software and hardware. One of the advantages that this scanner/printer system has is its flexibility that allows freely-selectable combination of a scanner and a printer to form the system.

However, some users do not want to prepare a printer with any special design both in terms of software and hardware, only for connecting a scanner, In other words, there has been a demand that this system be constructed using a general-purpose printer. Meanwhile, there are existing printers which are capable of directly printing a PDF (Portable Document Format) document without involving a driver. Therefore, in response to such a demand, a system has been proposed in which image data read by a scanner is converted into PDF by the scanner before being output to the printer. This system can be utilized as substitute for a copying machine.

With the above-mentioned system, however, there is a following problem if an original document consists of a large number of pages. For printing, the document is scanned by the scanner, which converts the scanned image data into PDF data, and the PDF data is output to the printer where it is printed. Since, by the nature of PDF format, the PDF file includes, at the very end of the file, description that has influences on printing of the whole pages. This causes the printer to wait the start of printing until the reception of the whole PDF file is completed. Therefore, for this conventional system, its FCOT (First Copy Output Time) is very large; far larger than that of ordinary copying machines.

### SUMMARY OF THE INVENTION

The present invention has been made in view of the above circumstances and to provide an image reading apparatus and an image processing method therefor, an image formation apparatus, an image processing system and an image processing method therefor, which are capable of improving the FCOT of a scanner/printer system.

According to an aspect of the present invention, an image reading apparatus connected to an image formation apparatus via a communication interface, comprises a reading unit that reads an original document, and generates image data for each page of the original document; an additional object instructing unit that instructs to add an additional object to the image data generated by the reading unit; an additional object generating unit that generates, when instructed to add the additional object by the additional object instructing unit, an additional object image according to the instructions; an image synthesizing unit that incorporates the additional object image generated by the additional object generating unit to the image data, when instructed by the additional object instructing unit to add the additional object; a file generating unit that generates a file of a predetermined format according to the image data output from the image synthesizing unit; and an output unit that outputs the file generated by the file generating unit to the image formation apparatus via the communication interface.

### BRIEF DESCRIPTION OF THE DRAWINGS

Embodiments of the present invention will be described in detail bas4ed on the following figures, wherein:

FIG. 1 illustrates an example of a system configuration of a scanner/printer system employing an image reading apparatus according to the present invention;

FIG. 2 is a block diagram illustrating an example of a functional configuration of the scanner shown in FIG. 1;

FIG. 3 is a flowchart illustrating the flow of processing executed by the scanner in the scanner/printer system;

FIG. 4 specifically illustrates the processing executed by the scanner/printer system;

FIG. 5 illustrates an example of a system configuration of a scanner/printer system employing an image reading apparatus and an image formation apparatus according to the present invention;

FIG. 6 is a block diagram illustrating an example of a functional configuration of the scanner shown in FIG. 5;

FIG. 7 is a flowchart illustrating the flow of processing executed by the scanner in the scanner/printer system;

FIG. 8 is a flowchart illustrating the flow of processing executed by the printer in the scanner/printer system; and

FIG. 9 specifically illustrates the processing executed by the scanner/printer system.

### DETAILED DESCRIPTION OF THE INVENTION

Detailed description will now be made, with reference to the attached drawings, of embodiments of an image reading apparatus and an image processing method therefor, an image formation apparatus, and an image processing system and an image processing method therefor according to the present invention.

### First Embodiment

FIG. I illustrates an example of a system configuration of the scanner/printer system employing an image reading apparatus according to the present invention.

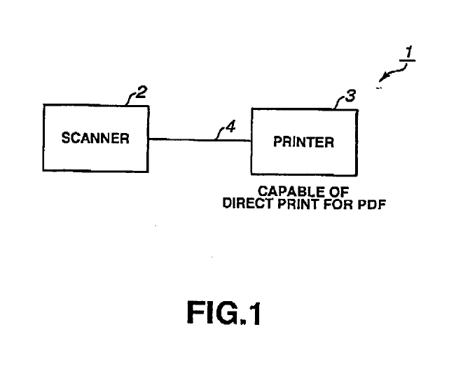

As shown in FIG. 1, the scanner/printer system 1 is formed by connecting a scanner 2 and a printer 3 by means of a USB (Universal Serial Bus) cable 4 having a USB standard interface. The interface connecting the scanner 2 and the printer 3 is not necessarily limited to the USB standard interface, but may be a wired circuit such as IEEE (the Institute of Electrical and Electronic Engineers) 1394 cable, LAN cable and RS-232C cable, or a radio circuit such as radio LAN and IrDA (Infared Data Association).

The scanner 2 is an image reading apparatus according to the present invention, while the printer 3 is a general-purpose printer having a function of directly printing PDF data which is received without involving a driver.

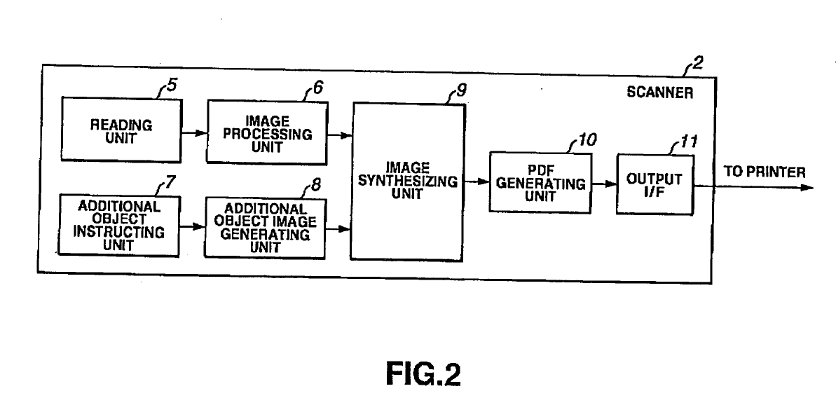

FIG. 2 is a block diagram illustrating an example of a functional configuration of the scanner 2 shown in FIG. 1.

As shown in FIG. 2, the scanner 2 includes a reading unit 5, an image processing unit 6, an additional object instructing unit 7, an additional object image generating unit 8, an image synthesizing unit 9, a PDF generating unit 10, and an output interface (hereafter, to be referred to as I/F) 11.

The reading unit 5 performs processing to scan an original document and generate image data (hereafter, to be referred to as “scanned image”). The reading unit 5 is composed of an imaging device such as a CCD, and either a carriage having the imaging device mounted thereon or an electric motor for moving the original document. The reading unit 5 generates one scanned image every time it has scanned one page of the original document has been scanned (hereafter, to be referred to as “one-page scanned image”). This means that, the reading unit 5 generates n-page scanned images by scanning n pages of the original document.

The image processing unit 6 performs image processing (e.g., image enlargement and reduction) on the scanned image generated by the reading unit 5. The image processing unit 6 is formed by a processor operated by software, or by an IC (Integrated Circuit) for image processing.

The additional object instructing unit 7 receives instructions to overprint a pattern image such as “CONFIDENTIAL” and “IMPORTANT” on the scanned image, or to print information relating to the printing at the head (top part) or foot (bottom part) of a sheet of paper hereafter, the pattern image and the information on the printing are to be referred to as the “additional object”). The additional object instructing unit 7 is formed by a display apparatus or a data entry key device.

The additional object image generating unit 8 generates an image of the additional object according to the instructions received by the additional object instructing unit 7. If the pattern image is prepared in advance, the additional object image generating unit 8 has only to fetch this pattern image from a memory.

The image synthesizing unit 9 performs processing to incorporate the additional object image generated by the additional object image generating unit 8 to the scanned image. The image synthesizing unit 9 incorporates the additional object image to each one-page scanned image.

The PDF generating unit 10 performs processing to generate a PDF file based on the synthesized image synthesized by the image synthesizing unit 9. The PDF generating unit 10 generates a PDF file for each-one page scanned image. This means that, n PDF files are generated when n pages of the original document have been read.

The output I/F 11 is a data communication interface which is connectable to the printer 3, and outputs the PDF file generated by the PDF generating unit 10 to the printer 3. As soon as a PDF file of one-page scanned image is generated, the output I/F 11 immediately outputs this PDF file of one-page scanned image to the printer 3.

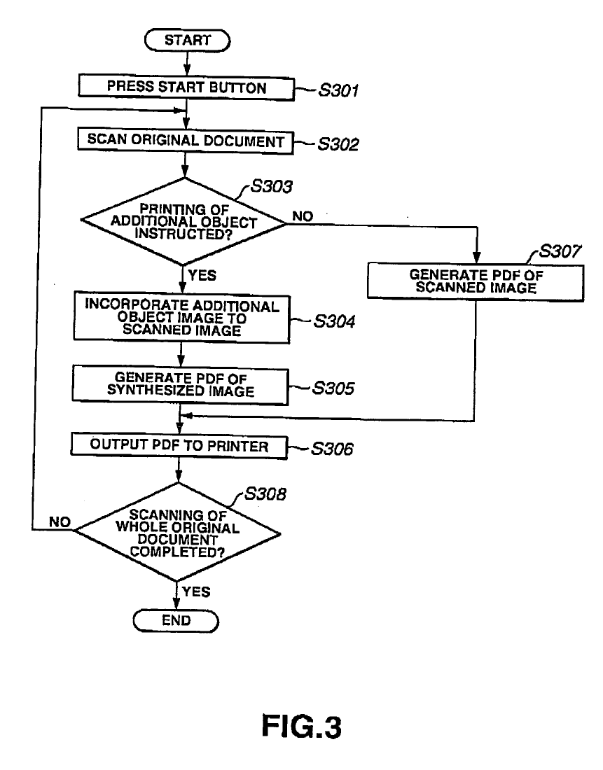

Description will now be made of the flow of the processing executed by the scanner in the scanner/printer system, with reference to the flowchart of FIG. 3.

When a read start button provided in the scanner is pressed (step S301), the reading unit scans the original document (step S302).

If the additional object instructing unit has received instructions to print an additional object (YES in step S303), the image synthesizing unit incorporates the additional object image to the scanned image to form a synthesized scanned image (step S304). The PDF generating unit generates a PDF file based on the synthesized scanned image (step S305), and the output I/F outputs the generated PDF file to the printer (step S306). The processing then proceeds step S308.

If the additional object instructing unit has not received instructions to print an additional object (NO in step S303), the PDF generating unit generates a PDF file based on the scanned image (step S307), and the processing proceeds to step S308.

If the scanning has not been completed for the whole original document (NO in step S308), the processing returns to step S302. In contrast, if the scanning has been completed for the whole original document (YES in step S308), the processing is completed.

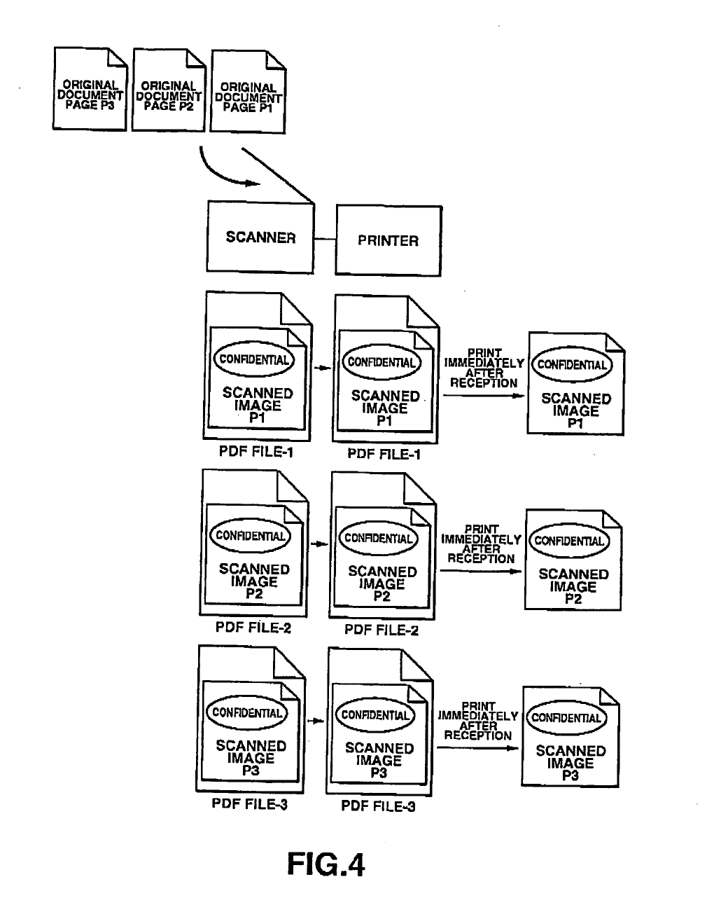

FIG. 4 specifically illustrates the processing performed by the scanner/printer system.

For example, in the case when three page original document (original document pages P1, P2, and P3) are to be scanned by the scanner, and printed out by the printer with a pattern image of “CONFIDENTIAL” added to the scanned image of each of the three pages of the original document, the scanner sequentially scans the original document pages P1, P2, and P3, while generating scanned images P1, P2, and P3.

Upon the scanned image P1 being generated, the pattern image of “CONFIDENTIAL” is incorporated to the scanned image P1, and a PDF file 1 is generated based on the scanned image P1 incorporated with the pattern image “CONFIDENTIAL”. The generated PDF file is output to the printer. Upon completing reception of the PDF file 1, the printer immediately starts printing the scanned image P1 incorporated with the pattern image “CONFIDENTIAL”.

Subsequently, upon the scanned image P2 being generated, the pattern image of “CONFIDENTIAL” is incorporated to the generated scanned image P2, and a PDF file 2 is generated based on the scanned image P2 incorporated with the pattern image of “CONFIDENTIAL”. The generated PDF file is output to the printer. Upon completing reception of the PDF file 2, the printer immediately starts printing the scanned image P2 incorporated with the pattern image “CONFIDENTIAL”.

Subsequently, upon the scanned image P3 being generated, the pattern image of “CONFIDENTIAL” is incorporated to the generated scanned image P3, and a PDF file 2 is generated based on the scanned image P3 incorporated with the pattern image of “CONFIDENTIAL”. The generated PDF file is output to the printer. Upon completing reception of the PDF file 3, the printer immediately starts printing the scanned image P3 incorporated with the pattern image “CONFIDENTIAL”.

In this manner, when an additional object is to be printed, an image of this additional object is incorporated to a scanned image before generating each PDF file consisting of one page. Therefore, the printer is able to start printing the scanned image incorporated with the image of the additional object immediately upon reception of each PDF file consisting of one page. This improves the FCOT of the printer.

The above description of the first embodiment has been made of a case in which an image of an additional object is incorporated to a scanned image and a PDF file is generated based on the synthesized image. However, instead of this, information indicating an additional object may be included at the head of a PDF file, so that the printer, upon receipt of the PDF file, prints the additional object according to the information included at the header of the PDF file to indicate the additional object.

### Second Embodiment

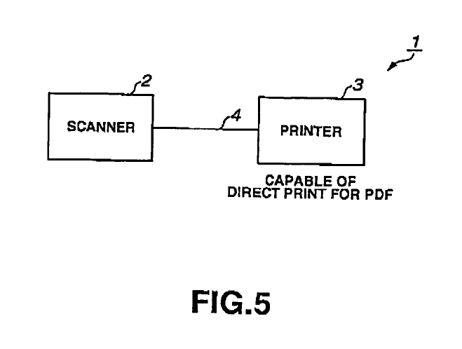

FIG. 5 shows an example of a system configuration of the scanner/printer system 1 employing an image reading apparatus and an image formation apparatus according to the present invention.

As shown in FIG. 5, the scanner/printer system 1 is formed by connecting a scanner 2 and a printer 3 by means of a USB cable 4 having a USB standard interface. The interface connecting the scanner 2 and the printer 3 needs not be limited to a USB standard interface, but the scanner 2 and the printer 3 may be connected by means of a wired circuit such as IEEE1394 cable, LAN cable and RS-232C cable, or a radio circuit such as radio LAN and IrDA.

The scanner 2 is an image reading apparatus according to the present invention, and the printer 3 is an image formation apparatus according to the present invention, which is capable of directly printing a PDF file received without involving a driver.

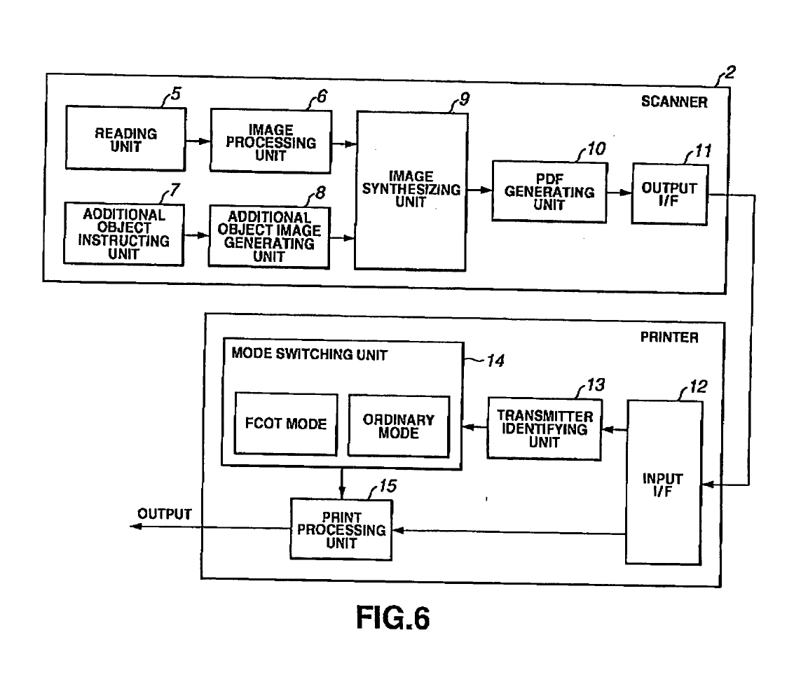

FIG. 6 is a block diagram illustrating an example of a functional configuration of the scanner 2 and the printer 3 of FIG. 5.

As shown in FIG. 6, the scanner 2 includes a reading unit 5, an image processing unit 6, an additional object instructing unit 7, an additional object image generating unit 8, an image synthesizing unit 9, a PDF generating unit 10, and an output I/F 11.

The reading unit 5 performs processing to scan an original document to generate image data (hereafter, referred to as “scanned image”). The reading unit 5 is composed of an imaging device such as a CCD, and either a carriage having the imaging device mounted thereon or an electric motor for moving the original document. The reading unit 5 generates one scanned image every time it has scanned one page of the original document (hereafter, to be referred to as “one-page scanned image). This means that, the reading unit 5 generates n-page scanned images by scanning n pages of the original document.

The image processing unit 6 performs image processing (e.g., image enlargement and reduction) on the scanned image generated by the reading unit 5. The image processing unit 6 is formed by a processor operated by software, or by an IC (Integrated Circuit) for image processing.

The additional object instructing unit 7 receives instructions to overprint a pattern image such as “CONFIDENTIAL” and “IMPORTANT” on the scanned image, or to print information relating to the printing in the head (top part) or foot (bottom part) of a sheet of paper (hereafter, the pattern image and the information on the printing are to be referred to as “additional object”). The additional object instructing unit 7 is formed by a display apparatus or a data entry key device.

The additional object image generating unit 8 generates an image of the additional object according to the instructions received by the additional object instructing unit 7. If the pattern image is prepared in advance, the additional object image generating unit 8 has only to fetch this pattern image from a memory.

The image synthesizing unit 9 performs processing to incorporate the additional object image generated by the additional object image generating unit 8 to the scanned image. The image synthesizing unit 9 incorporates the additional object image to each one-page scanned image.

The PDF generating unit 10 performs processing to generate a PDF file based on the synthesized image synthesized by the image synthesizing unit 9. The PDF generating unit l0 generates a PDF file for each one-page scanned image. This means that, n PDF files are generated when n pages of original documents have been scanned.

The output I/F 11 is a data communication interface which is connectable to the printer to output a PDF file generated by the PDF generating unit 10 to the printer.

As shown in FIG. 6, the printer 3 includes an input I/F 12, a transmitter identifying unit 13, a mode switching unit 14, and a print processing unit 15.

The input I/F 12 is a data communication interface which is connectable to the scanner 2 to receive a PDF file output from the scanner 2.

The transmitter identifying unit 13 identifies a type of the transmitter from which the input I/F 12 receives data (e.g., the scanner 2 according to the present invention, a general-purpose scanner, a digital camera, and a PC (Personal Computer)).

If the transmitter identifying unit 13 determines that the transmitter is the scanner 2 according to the present invention, the mode switching unit 14 switches to the mode in which the printer stats printing the scanned image while receiving the PDF file (hereafter, to be referred to as “FCOT mode”). Whereas, if the transmitter identifying unit 13 determines that the transmitter is not the scanner 2 according to the present invention, the mode switching unit 14 switches to the mode in which the printer does not start printing until reception of the whole PDF file is completed (hereafter, to be referred to as “ordinary mode”).

The print processing unit 15 performs print processing on the scanned image according to the mode which the mode switching unit 14 has switched to. Specifically, in the FCOT mode, upon completing reception of one-page scanned image of a multiple-page PDF file while receiving the PDF file, the print processing unit 15 performs print processing on the received scanned image. In the ordinary mode the print processing unit 15 performs print processing after completing reception of the whole PDF file or the whole print data.

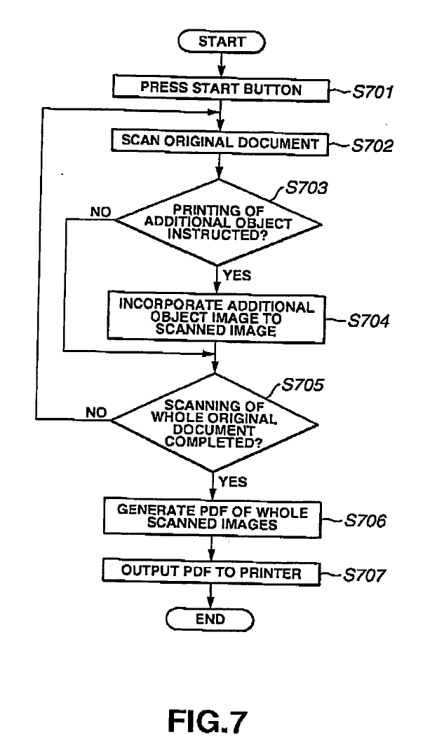

Description will now be made of the flow of processing executed by the scanner of the scanner/printer system, with reference to the flowchart of FIG. 7.

When a read start button of the scanner is pressed (step S701), the reading unit scans an original document (step S702).

If the additional object instructing unit has received instructions to print an additional object (YES in step S703), the image synthesizing unit incorporates the additional object image to the scanned image (step S704), and the processing proceeds to step S705.

If the additional object instructing unit has not received, in step S703, instructions to print an additional object (NO in step S703), the processing directly proceeds to step S705.

If the scanning has not been completed for the whole original document (NO in step S705), the processing returns to step S702.

In contrast, if the scanning has been completed in step S705 for the whole original document (YES in step S705), the PDF generating unit generates a PDF file based on the scanned images of the whole original document (step S706), and the output I/F outputs the generated PDF file to the printer (step S707) to complete the processing.

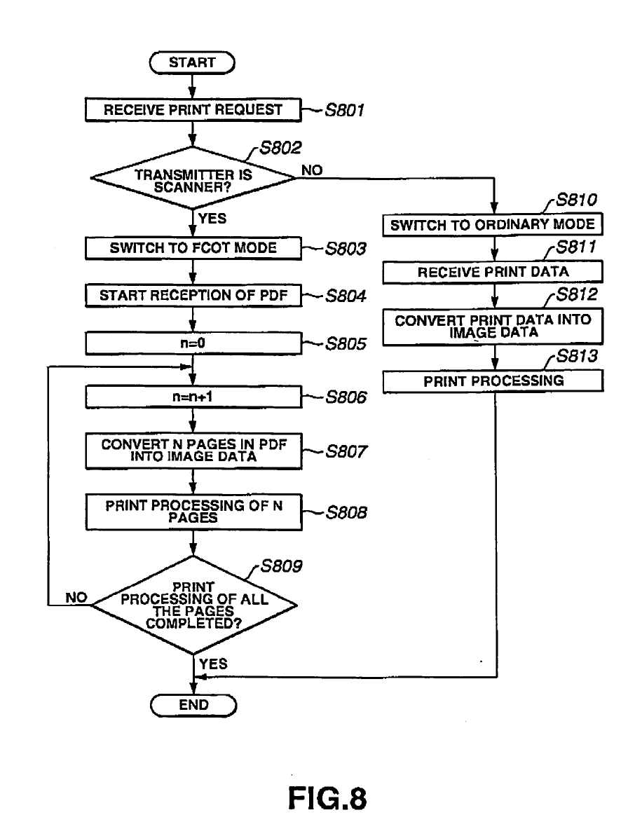

Description will now be made of the flow of the processing by the printer of the scanner/printer system with reference to the flowchart of FIG. 8.

When the input I/F receives a print request from the transmitter (step S801), the transmitter identifying unit identifies a type of the transmitter (step S802). If the transmitter identifying unit determines that the transmitter is the scanner according to the present invention (YES in step S802), the processing proceeds to step S803. Whereas, if the transmitter identifying unit determines that the transmitter is not the scanner according to the present invention (NO in step S802), the processing proceeds to step S809.

When the transmitter identifying unit determines that the transmitter is the scanner according to the present invention (YES in step S802), the mode switching unit switches to the FCOT mode (step S803), and the input I/F starts receiving the PDF file (step S804). The variable n is set to zero (step S805), and one is added to the variable n (n=n+1) (step S806). The print processing unit generates image data from n pages of the PDF file (step S807), and the print processing unit performs print processing on the n-page image data (step S808). If there are any pages in the PDF file which have not been subjected to the print processing (NO in step S809), the processing returns to step S806, If the print processing has been completed for all the pages in the PDF file (YES in step S809), the processing is completed.

If the transmitter identifying unit determines, in step S802, that the transmitter is not the scanner according to the present invention (NO in step S802), the mode switching unit switches to the ordinary mode (step S810), in which the input I/F receives print data or a PDF file from the transmitter (step S811). The print processing unit generates image data based on the print data (step S812). The print processing unit performs print processing on the generated image data (step S813), and the processing is completed.

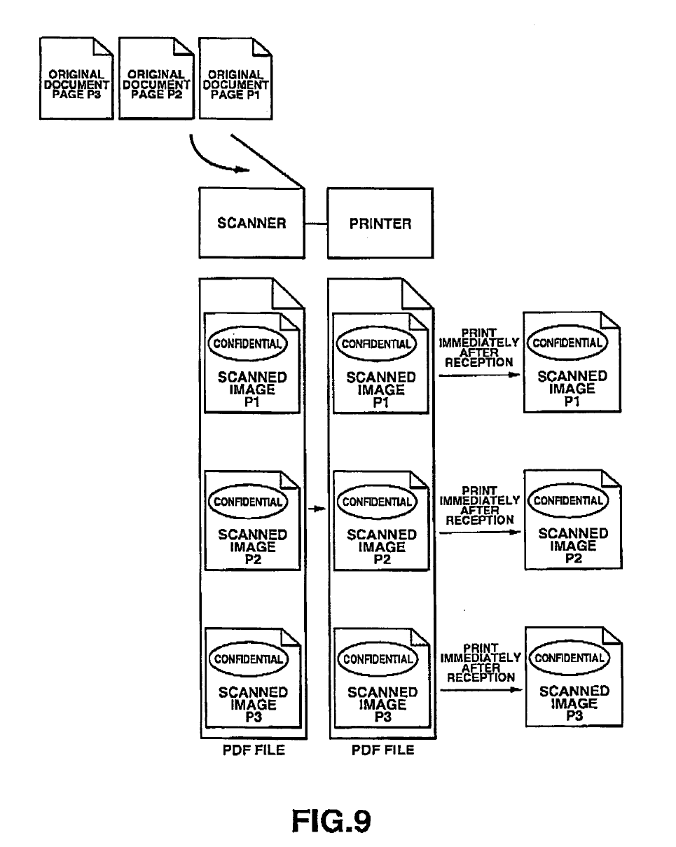

FIG. 9 is a drawing specifically illustrating the processing performed by the scanner/printer system.

For example, in the case when three page original document (original document pages P1, P2, and P3) are to be scanned by the scanner and printed out by the printer with a pattern image of “CONFIDENTIAL” added to the scanned image of each of the three pages of the original document, the scanner sequentially scans the original document pages P1, P2, and P3, while generating scanned images P1, P2, and P3.

Upon the scanned image P1 being generated, the pattern image of “CONFIDENTIAL” is incorporated to the scanned image P1 . Subsequently, upon the scanned image P2 being generated, the pattern image of “CONFIDENTIAL” is incorporated to the scanned image P2 . Subsequently, upon the scanned image P3 being generated, the pattern image of “CONFIDENTIAL” is incorporated to the scanned image P3. Then, a PDF file is generated based on the scanned images P1, P2, and P3 having, respectively, the pattern image “CONFIDENTIAL” incorporated therein, and the generated PDF file is output to the printer.

While receiving the PDF file, the printer starts printing the scanned image P1 having the pattern image “CONFIDENTIAL” incorporated therein immediately upon completing reception of the scanned image P1 in the PDF file. While still receiving the PDF file, the printer starts printing the scanned image P2 having the pattern image “CONFIDENTIAL” incorporated therein immediately upon completing reception of the scanned image P2 in the PDP file. Further, while still receiving the PDF file, the printer starts printing the scanned image P3 having the pattern image “CONFIDENTIAL” incorporated therein immediately upon completing reception of the scanned image P3 in the PDF file.

Accordingly, the scanner does not place any information on the additional object at the end of a PDF file, but generates a PDF file after incorporating the additional object image to all the scanned images. This allows the printer to perform print processing, while receiving the PDF file, immediately upon receiving each one-page scanned image of the PDF file. As a result, the FCOT of the printer is improved.

The above description of the second embodiment has been made in term of a case in which an additional object image is incorporated to a scanned image, and a PDF file is generated based on the synthesized image. However, instead of this, information indicating the additional object may be included either at the head of the PDF file, or before the scanned image on each page in the PDF file, so that the printer prints the additional object, when receiving the PDF file, according to the information indicating the additional object which is included at the head of the PDF file or before the scanned image on each page.

According to the above description of the first and second embodiments, the image formation apparatus capable of directly printing a PDF file is an essential feature of the invention, and hence it is fundamental that the image reading apparatus converts a scanned image into a PDF file. This means that the PDF generating unit is an essential element of the invention. However, it is obvious that, when connected to an image formation apparatus capable of directly printing a file of a format other PDF (such image formation apparatus actually exists), the image reading apparatus may be modified, within the scope of the invention, so as to convert the scanned image into the file format which can be directly printed by the image formation apparatus. This means that the PDF generating unit may be replaced with a unit for generating a file of such other format.

With the above configuration, when an additional object is to be printed, the image of this additional object is synthesized with a scanned image before generating a PDF file in a unit of page. Therefore, upon receiving each page of the PDF file, a printer is able to start printing the scanned image synthesized with the image of the additional object. Thus, the FCOT of the printer can be improved.

Further, a scanner will not insert information on the additional object at the very end of a PDF file, but generates a PDF file only after adding the image of the additional object to all the scanned images. Therefore, while receiving the PDF file, the printer is enabled, upon completing reception of scanned image of each page in the PDF file, to perform print processing on the received scanned image. Accordingly, the FCOT of the printer can be improved.

As described above, according to an aspect of the present invention, an image reading apparatus connected to an image formation apparatus via a communication interface, comprises a reading unit that reads an original document, and generates image data for each page of the original document; an additional object instructing unit that instructs to add an additional object to the image data generated by the reading unit; an additional object generating unit that generates, when instructed to add the additional object by the additional object instructing unit, an additional object image according to the instructions; an image synthesizing unit that incorporates the additional object image generated by the additional object generating unit to the image data, when instructed by the additional object instructing unit to add the additional object; a file generating unit that generates a file of a predetermined format according to the image data output from the image synthesizing unit; and an output unit that outputs the file generated by the file generating unit to the image formation apparatus via the communication interface,

According to another aspect of the present invention, in an image processing system having an image reading apparatus and an image formation apparatus connected to each other via a communication interface, the image reading apparatus comprises a reading unit that reads an original document, and generates image data for each of the original document; an additional object instructing unit that instructs to add an additional object to the image data generated by the reading unit; an additional object generating unit that generates, when instructed to add the additional object by the additional object instructing unit, an additional object image according to the instructions; an image synthesizing unit that incorporates the additional object image generated by the additional object generating unit to the image data, when instructed by the additional object instructing unit to add the additional object; a file generating unit that generates a file of a predetermined format according to the image data output from the image synthesizing unit; and an output unit that outputs the file generated by the file generating unit to the image formation apparatus via the communication interface, and the image formation apparatus comprises an input unit that receives the file output from the image reading apparatus via the communication interface; and an image formation unit that, while the input unit is receiving the file, forms an image of image data contained in the file every time the reception of the image data has been completed.

According to still another aspect of the present invention in the image processing system, the image formation apparatus further comprises an output source identifying unit that identifies a type of output source of the data received by the input unit; and a mode switching unit that switches mode of image formation processing performed by the image formation unit according to the type of the output source identified by the output source identifying unit, wherein when the type of the output source is identified as the image reading apparatus, the mode switching unit switches to a mode in which, while the input unit is receiving the file, an image of image data contained in the file is formed every time the reception of the image data has been completed, and when the type of the output source is identified as an apparatus other than the image reading apparatus, the mode switching unit switches to a mode in which an image of data is formed only after the input unit has completed reception of whole data.

According to even another aspect of the present invention, an image reading apparatus connected to an image formation apparatus via a communication interface, comprises a reading unit that reads an original document and generates image data for each page of the original document; an additional object instructing unit that instructs to add an additional object to the image data generated by the reading unit; an additional object generating unit that generates, when instructed to add the additional object by the additional object instructing unit, an additional object image according to the instructions; an image synthesizing unit that incorporates the additional object image generated by the additional object generating unit to the image data, when instructed by the additional object instructing unit to add the additional object; a file generating unit that generates a single file of a predetermined format based on whole image data output by the image synthesizing unit; and an output unit that outputs the file generated by the file generating unit to the image formation apparatus via the communication interface.

According to yet another aspect of the invention, an image formation apparatus connected to an image reading apparatus via a communication interface, comprises an input unit that receives a single file of a predetermined format which is generated based on whole image data of an original document that is read and output by the image reading apparatus via the communication interface; and an image formation unit that, while the input unit is receiving the file, forms an image of image data contained in the file every time the reception of the image data has been completed.

According to further aspect of the present invention, the image formation apparatus further comprises an output source identifying unit that identifies a type of the output source of the input data received by the input unit; and a mode switching unit that switches the mode of image formation processing performed by the image formation unit based on the type of the output source identified by the output source identifying unit, wherein when the type of the output source is identified as the image reading apparatus, the mode switching unit switches to a mode in which, while the input unit is receiving the file, an image of image data contained in the file is formed every time the reception of the image data has been completed; and when the type of the output source is identified as an apparatus other than the image reading apparatus, the mode switching unit switches to a mode in which an image of data is formed only after the input unit has completed reception of whole data.

According to still further aspect of the present invention, an image processing method for an image reading apparatus connected to an image formation apparatus via a communication interface, comprises reading an original document and generating image data for each page of the original document by means of a reading unit; generating an image of an additional object by means of an additional object generating unit when instructed by an additional object instructing unit to add the additional object to the image data read by the reading unit; incorporating the additional object image generated by the additional object generating unit to the image data by means of an image synthesizing unit when instructed by the additional object instructing unit to add the additional object; generating a file of a predetermined format based on the image data output from the image synthesizing unit by means of a file generating unit; and outputting the file generated by the file generating unit to the image formation apparatus via the communication interface by means of an output unit.

According to even further aspect of the present invention, in an image processing method for an image processing system having an image reading apparatus and an image formation apparatus connected to each other via a communication interface, the image reading apparatus performs scanning an original document and generating image data for each page of the original document by means of a reading unit; generating an image of an additional object according to instructions by means of an additional object generating unit when instructed by an additional object instructing unit to add the additional object to the image data generated by the reading unit; incorporating the additional object image generated by the additional object generating unit to the image data by means of an image synthesizing unit when instructed by the additional object instructing unit to add the additional object; generating a single file of a predetermined format based on whole image data output from the image synthesizing unit by means of a file generating unit; and outputting the file generated by the file generating unit to the image formation apparatus via the communication interface by means of an output unit, and the image formation apparatus performs receiving the file output from the image reading apparatus via the communication interface by means of an input unit; and forming an image of image data contained in the file every time the reception of the image data has been completed by means of an image formation unit while the input unit is receiving the file.

According to yet further aspect of the present invention, in the image processing method for the image processing system according to even further aspect of the present invention, the image formation apparatus performs identifying a type of an output source of the input data received by the input unit by means of an output source identifying unit; switching by means of a mode switching unit to a mode in which, every time the reception of image data contained in the file is completed while the input unit is receiving the file, an image is formed from the received image data when the type of the output source is identified as the image reading apparatus; and switching by means of the mode switching unit to a mode in which after the input unit has completed the reception of whole data contained in the file, images are formed from whole data received when the type of the output source is identified as an apparatus other than the image reading apparatus.

The forgoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-183641 filed on Jun. 23, 2005 including specification, claims, drawings and abstract is incorporated herein by reference in its entirety.

What is claimed is:

1. An image reading apparatus connected to an image formation apparatus via a communication interface, comprising:
a reading unit that reads an original document, and generates image data for each page of the original document;
an additional object instructing unit that instructs to add an additional object to the image data generated by the reading unit;
an additional object generating unit that generates, when instructed to add the additional object by the additional object instructing unit, an additional object image according to the instructions;
an image synthesizing unit that incorporates the additional object image generated by the additional object generating unit to the image data, when instructed by the additional object instructing unit to add the additional object;
a file generating unit that generates a file of a predetermined format according to the image data output from the image synthesizing unit; and
an output unit that outputs the file generated by the file generating unit to the image formation apparatus via the communication interface.

2. An image processing system having an image reading apparatus and an image formation apparatus connected to each other via a communication interface wherein
the image reading apparatus comprises:
a reading unit that reads an original document, and generates image data for each of the original document;
an additional object instructing unit that instructs to add an additional object to the image data generated by the reading unit;
an additional object generating unit that generates, when instructed to add the additional object by the additional object instructing unit, an additional object image according to the instructions;
an image synthesizing unit that incorporates the additional object image generated by the additional object generating unit to the image data, when instructed by the additional object instructing unit to add the additional object;
a file generating unit that generates a single file of a predetermined format based on whole image data output by the image synthesizing unit;
an output unit that outputs the file generated by the file generating unit to the image formation apparatus via the communication interface, and
the image formation apparatus comprises:
an input unit that receives the file output from the image reading apparatus via the communication interface; and
an image formation unit that, while the input unit is receiving the file, forms an image of image data contained in the file every time the reception of the image data has been completed.

3. The image processing system according to claim 2, wherein the image formation apparatus further comprises:
an output source identifying unit that identifies a type of output source of the data received by the input unit; and
a mode switching unit that switches mode of image formation processing performed by the image formation unit according to the type of the output source identified by the output source identifying unit, wherein
when the type of the output source is identified as the image reading apparatus, the mode switching unit switches to a mode in which, while the input unit is receiving the file, an image of image data contained in the file is formed every time the reception of the image data has been completed, and
when the type of the output source is identified as an apparatus other than the image reading apparatus, the mode switching unit switches to a mode in which an image of data is formed only after the input unit has completed reception of whole data.

4. An image reading apparatus connected to an image formation apparatus via a communication interface comprising:
a reading unit that reads an original document and generates image data for each page of the original document;
an additional object instructing unit that instructs to add an additional object to the image data generated by the reading unit;
an additional object generating unit that generates, when instructed to add the additional object by the additional object instructing unit, an additional object image according to the instructions;
an image synthesizing unit that incorporates the additional object image generated by the additional object generating unit to the image data, when instructed by the additional object instructing unit to add the additional object;
a file generating unit that generates a single file of a predetermined format based on whole image data output by the image synthesizing unit; and
an output unit that outputs the file generated by the file generating unit to the image formation apparatus via the communication interface.

5. An image formation apparatus connected to an image reading apparatus via a communication interface comprising:
an input unit that receives a single file of a predetermined format which is generated based on whole image data of an original document that is read and output by the image reading apparatus via the communication interface; and
an image formation unit that, while the input unit is receiving the file, forms an image of image data contained in the file every time the reception of the image data has been completed.

6. The image formation apparatus according to claim 5, comprising:
an output source identifying unit that identifies a type of the output source of the input data received by the input unit; and
a mode switching unit that switches the mode of image formation processing performed by the image formation unit based on the type of the output source identified by the output source identifying unit, wherein
when the type of the output source is identified as the image reading apparatus, the mode switching unit switches to a mode in which, while the input unit is receiving the file, an image of image data contained in the file is formed every time the reception of the image data has been completed; and
when the type of the output source is identified as an apparatus other than the image reading apparatus, the mode switching unit switches to a mode in which an image of data is formed only after the input unit has completed reception of whole data.

7. An image processing method for an image reading apparatus connected to an image formation apparatus via a communication interface, the method comprising:
reading an original document and generating image data for each page of the original document by means of a reading unit;
generating an image of an additional object by means of an additional object generating unit when instructed by an additional object instructing unit to add the additional object to the image data read by the reading unit;
incorporating the additional object image generated by the additional object generating unit to the image data by means of an image synthesizing unit when instructed by the additional object instructing unit to add the additional object;
generating a file of a predetermined format based on the image data output from the image synthesizing unit by means of a file generating unit; and
outputting the file generated by the file generating unit to the image formation apparatus via the communication interface by means of an output unit.

8. An image processing method for an image processing system having an image reading apparatus and an image formation apparatus connected to each other via a communication interface, wherein
the image reading apparatus performs:
scanning an original document and generating image data for each page of the original document by means of a reading unit;
generating an image of an additional object according to instructions by means of an additional object generating unit when instructed by an additional object instructing unit to add the additional object to the image data generated by the reading unit;
incorporating the additional object image generated by the additional object generating unit to the image data by means of an image synthesizing unit when instructed by the additional object instructing unit to add the additional object;
generating a single file of a predetermined format based on whole image data output from the image synthesizing unit by means of a file generating unit; and
outputting the file generated by the file generating unit to the image formation apparatus via the communication interface by means of an output unit, and
the image formation apparatus performs:
receiving the file output from the image reading apparatus via the communication interface by means of an input unit; and
forming an image of image data contained in the file every time the reception of the image data has been completed by means of an image formation unit while the input unit is receiving the file.

9. The image processing method for the image processing system according to claim 8, wherein
the image formation apparatus performs:
identifying a type of an output source of the input data received by the input unit by means of an output source identifying unit;
switching by means of a mode switching unit to a mode in which, every time the reception of image data contained in the file is completed while the input unit is receiving the file, an image is formed from the received image data when the type of the output source is identified as the image reading apparatus; and
switching by means of the mode switching unit to a mode in which after the input unit has completed the reception of whole data contained in the file, images are formed from whole data received when the type of the output source is identified as an apparatus other than the image reading apparatus.
